(19) United States
(12) Patent Application Publication
(10) Pub. No.: US 2004/0237106 A1
(43) Pub. Date: Nov. 25, 2004

(54) System for filtering digital data transmissions in accordance with user profiles

(76) Inventor: Sebastien Brule, La Ciotat (FR)

Correspondence Address: GREENBLUM & BERNSTEIN, P.L.C., 1950 ROLAND CLARKE PLACE, RESTON, VA, 20191, US

(21) Appl. No.: 10/479,969

(22) PCT Filed: Jun. 12, 2001
(86) PCT No.: PCT/FR01/01810

(51) Int. Cl. H04N 7/025; H04N 5/445; G06F 3/00

(52) U.S. Cl. 725/46; 725/9; 725/34

(57) ABSTRACT

The invention concerns a system for filtering digital data transmissions in accordance with user profiles. It is based on the use of a receiver (1, 2) of “packet-encoded” digital transmissions associated with a filtering means (6) comprising encoded elements corresponding to the profile (age, sex, tastes, and the like) of the user, each packet of the transmission including one or several specific zones designed to interact, through an appropriate software, with the filtering means (6) so that only the packets corresponding to the profile are taken into account by the receiver and received by the user. The invention generally relates to the field of digital data transmission of all types using encoding by “packets” consisting of a set of data routed in blocks in a network.

The present invention relates to a system for filtering digital data transmissions in accordance with user profiles.

It generally relates to the field of digital data transmission of all types using encoding by “packets” constituted of a set of data routed in blocks in a network.

Mastering data processing, due to the digital manipulation of signals of all types, currently allows transforming any analog signal, particularly audio or video, into a digital signal. Using these types of signals has substantial advantages: the neutralization of noise and interference, the suppression of the effect of aging on magnetic recordings, an easier and more reliable processing in amplifiers and transmitters, the possibility of benefiting from complex techniques, called digital compression techniques, allowing the decrease in the width of the pass band used per channel and thus the increase in the number of channels that can be transmitted in a window of given frequencies.

The physical infrastructure of a digital transmission network can comprise copper cables (co-axial or twisted in pairs), optical fibers, radio relays, transmission satellites, ordinary or digital telephone lines obtained from either one of these techniques, laser or infrared beams, the television broadcasting cable, etc.

Data and information are increasingly distributed in the form of digital flows sectioned into “packets.” This technique, used for the Internet, lends itself particularly well to satellite transmission and is now used for television, which is progressively being integrated into the new networks for multimedia data communication.

Currently, only a few dozen networks still operate on analog, and probably not for very long. A big winner, digital transmission allows not only multiplying the satellite broadcasting capacities, but it also allows improving sound and picture quality.

In addition, digital satellite transmission allows sending data to terminals (television sets or computers) at high speed.

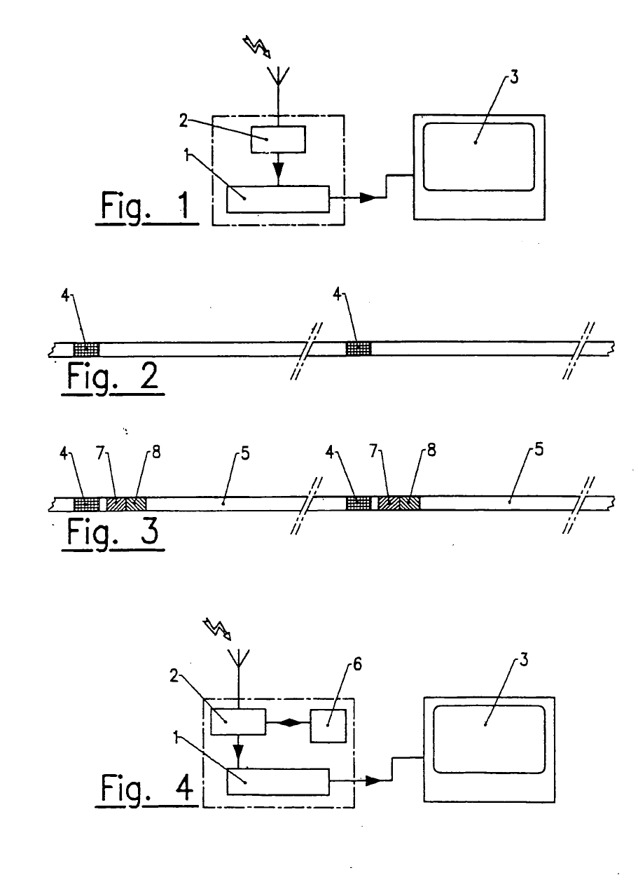

The digital signal receivers, such as satellite decoders 1 or computers equipped with a receiving card 2, can select the data to be received on a screen 3 in accordance with the user's selection (for instance, a given television network). (FIG. 1). For this, the receiving systems proceed by filtering identification tables 4 transmitted by the broadcast stations and positioned at the head of the packets, before the data zone 5 that contains the information (FIG. 2). These tables describe all of the services or programs available, as well as the parameters that allow “locking” on the information selected. It is by means of a software for searching or controlling the receiving elements, which is located in the receiver, that the user selects one network or another, one service or another, or the data type.

Currently, the broadcasting of digital television programs by satellite usually occurs according to a protocol designated by the acronym “MPEG” and characterized by packets having 188 bytes, at the head of each of which is positioned an identifier (“PID:” Packet Identifier) allowing the identification of a flow of packets (on a digital television network, the video data are transmitted on one “PID,” the audio data on another “PID”).

If it is currently possible for a broadcast station to “target” a group of users, it is by using single addresses generally contained in a chip. Therefore, in order to send information to one user (or a group of users), the distributor includes one address in the information which corresponds to a single chip or a set of chips. All of this information is sent to all of the chips and filtered by all of the receivers, whether or not it is addressed to them. Furthermore, it is only one number, one address, which enables the targeting; this number has no meaning. For instance, it gives no information on what interests the subscriber.

The object of the present invention is to overcome this drawback by directing the information with a notion of meaning toward one group of users or another. It allows integrating the notion of profile in the distribution of data.

The system is based on the use of a digital transmission receiver associated with a filtering means comprising encoded elements that correspond to the profile (age, sex, tastes, etc.) of the user, each transmission packet comprising one or more specific zones designed for interacting, through an appropriate software, with the filtering means such that only the packets corresponding to the profile are taken into account by the receiver and received by the user.

On the attached drawings that are given by way of non-limiting examples of embodiment of the object of the invention:

FIGS. 1 and 2, already cited, show the synoptic diagram of a current receiving station and a digital distribution flow of a known type, respectively,

FIG. 3 shows a digital distribution flow comprising encoded zones corresponding to the profiles of the targeted users,

and FIG. 4 is the synoptic diagram of a receiving station according to the invention.

The system is based on three main notions:

a user is represented by his profile,

a broadcast station can directly reach this or that profile or groups of profiles, for instance, for targeting its advertising depending on the tastes of the users,

it is not the software of the receiver or of the user that locks on the information, but it is the transmitted flow that controls the receipt of the information.

The user profile is encoded and can possibly be modified according to his wishes.

For instance, a profile can be shown by a succession of 128 bits, indicating, for a given user:

sex, age, number of children,

type of residence: apartment, single home, etc.,

standard of living,

preferences with regards to the information: regional, national, international,

activities: sports, stock exchange, etc.,

interests: art, travel, etc.,

food preferences,

etc.

The encoded profile can be one stored in a chip or in any peripheral memory zone. It is used directly by a filtering means 6, constituted of an integrated or non-integrated electronic module associated with the receiving device, as one of the parameters for filtering the information. In other words, each receiver is characterized by its profile filters.

The parameters that are lacking for a user to receive the data that the distributor wishes to send him will be transmitted in the data itself, which is retrieved and used “on the fly” by the receiving system.

In the system proposed, the parameters corresponding to a profile or a group of profiles will be transmitted in the data, in one or several specific zones 7, 8 (FIG. 3), and retrieved continuously in the flow by the filtering means 6 that sets its own parameters on the fly with those that it has just retrieved.

This principle allows targeting data automatically without direct interaction from the user or from a software present in the receiver or a chip, for instance, for viewing prerecorded information.

Due to the possibility of storing a profile on a memory support, such as a chip or a flash memory, each user can have a portable support enabling him to access his profiled data due to stations or installed public terminals. For instance, newspaper distributors, kiosks, department stores and hotels can offer terminals that are accessible to everyone and which allow inserting a portable “profile support.” This support can also allow storing the data retrieved for a subsequent use.

The system also allows targeting the information transmitted in real time, or to enable a user to receive the data that he wishes.

In the case of television programs transmitted by satellites according to the “MPEG” protocol, the specific zones of filtering parameters will be constituted of a “MATCH” zone 7 providing the succession of the first bytes of the desired packets, and a “MASK” zone 8 possibly providing a certain flexibility to the parameters of the “MATCH” zone (for instance, ultimately the value of the 5^{th} bit of the 4^{th} byte from “MATCH” is not to be taken into account, etc.).

In the system according to the invention, the user profile is a new parameter. The filtering means 6 sets its own parameters on the fly by continuously retrieving the “MATCH” and “MASK” parameters transmitted in the flow of data.

This principle allows automatically targeting the data without direct interaction from the user or from a software present in the receiver or a chip.

The system allows replacing (upon receipt) the identifier (“PID”) of a flow with another, thus allowing (for instance, depending on the profiles) to replace generic advertising with targeted advertising at moments desired by the broadcast stations.

This solution allows using numerous commercially available digital decoders without having to modify them.

Examples of applications:

Sound tapes corresponding to news similar to those broadcast on the radio are downloaded on player-recorders, each user using his storing capacity in accordance with his profile.

Likewise, hotels can equip the rooms with stations allowing anyone to connect their portable “profile support” (for instance, an advanced mobile telephone, containing the profile, allowing to download digital sound data, text, and possibly images).

The big distributors can allow anyone to download on a support, or to print, product offers to reward customers depending on their types of purchases, identified by the support itself or another chip (a synthesis of their profile), by proposing to them offers that may vary, even during each of their sessions. This system can be used as a complement to the stations, located in the users' home, which use can also allow refining the profiles and receiving discounts or gifts offered by the broadcast stations.

Media distributors can create free discovery channels giving clients a glimpse of new items in accordance with their profiles, which they can hear from their stations, or paying channels offering more complete services, or yet create terminals in their stores, allowing anyone to find these new items on-site by simply inserting their portable “profile support” used at home.

The positioning of various constitutive elements gives the object of the invention a maximum of useful effects that, until now, had not been obtained by similar systems.

1. System for filtering digital data transmissions in accordance with user profiles, with the object of transmitting digital data of all types using the encoding by “packets” constituted of a set of data routed in blocks in a network, the receiver of digital transmissions being associated with a filtering means (6) comprising encoded elements corresponding to the user profile and representing, for instance, his age, sex, or tastes, each transmission packet comprising one or several specific zones (7, 8) designed so as to interact with said filtering means, through an appropriate software, such that only the packets corresponding to said profile are taken into account by the receiver, the selection of the information received being controlled by the flow of the transmission in accordance with a profile or with a group of profiles selected by the broadcast station and not by the software of the receiver or of the user,
characterized in that it is provided to receive the information transmitted in real time, the specific zones of filtering parameters being constituted of a “MATCH” zone (7) providing the succession of the first bytes of the desired packets, and a “MASK” zone (8) allowing to have a certain flexibility in the parameters of the “MATCH” zone, for instance, by eliminating the effect of one or several bits of this zone, the filtering means (6) setting its own parameters on the fly by continuously retrieving the “MATCH” and “MASK” parameters transmitted in the flow of data, the user profile thus becoming a new parameter.

2. System for filtering digital data transmissions according to claim 1, characterized in that the filtering means (6) is constituted of an electronic module added to an existing digital decoder.

3. System for filtering digital data transmissions according to claim 1, characterized in that the filtering means (6) is constituted of an electronic module integrated into the receiver.

4. System for filtering digital data transmissions according to claim 1, characterized in that the user profile is formed of a code that can be modified according to his wish.

5. System for filtering digital data transmissions according to claim 1, characterized in that the user profile is constituted of a code stored on a chip or another portable support that can be used, for instance, on public terminals adapted to receive them.

6. System for filtering digital data transmissions according to claim 1, characterized in that it is adapted to receive television programs transmitted by satellite according to the “MPEG” protocol.
